(19) United States
(12) Patent Application Publication
(10) Pub. No.: US 2011/0238543 A1
(43) Pub. Date: Sep. 29, 2011

(54) SYSTEM AND METHOD OF VERIFYING DRIVING LOGS WITH GPS DATA

(76) Inventors: Ivan E. Paez, New Berlin, WI (US); Gregory J. Lofy, Deerfeld Beach, FL (US); John F. Van Nortwick, Hartland, WI (US)

(21) Appl. No.: 12/732,994

(22) Filed: Mar. 26, 2010

(51) Int. Cl. G06Q 10/00; G01C 21/00; G06Q 50/00

(52) U.S. Cl. 705/32; 701/213; 705/338; 705/341

(57) ABSTRACT

A system and method of verifying driver log entries against corresponding independent location information to verify the accuracy of the entries and to identify exceptions and data inconsistencies between the log entries and the independent location information.

### BACKGROUND

In the truck transportation industry, governmental regulations mandate that drivers or operators record their activities including driving and non-driving related activities whenever they are on duty. Governmental regulations limit the total number of hours that a driver or operator can drive a vehicle before being required to stop for a mandated rest period. Governmental regulations also limit the total number of hours including all driving and non-driving activities that driver or operator can work before being required to stand down for a mandated rest period.

Since most drivers travel alone, or at most in pairs, and most driving or non-driving related activities occur at locations remote from their base of operations, direct supervision of drivers is not always possible or feasible. However, firms which own the trucks and/or employ the drivers may be held liable for any failures of the drivers to abide by the time-in-service regulations. It is not uncommon for errors to be made in record keeping by the drivers which may result in their operating beyond the mandated time limits. It is also, unfortunately, not uncommon for drivers to falsify their log books to permit them to work for more than the mandated time limits. Many drivers are compensated on a miles-driven basis, which creates an incentive to exceed the mandated limits to maximize pay.

It is also not uncommon for drivers to exceed company or legal driving restrictions in an effort to maximize the miles driven in a particular time period. For example, speeding may permit a driver to reach his destination within the mandated time limits but is obviously a practice that the truck owner and/or driver employer would like to avoid. Since the log that a driver is required to keep will list time driven and miles covered, as well as time in service, a driver would need to falsify the log book with regard to one or more entries to be able to cover up the excesses in speed, mileage or time in service.

Thus, it is desirable to have some method or system that will permit truck owners and/or driver employers to verify log entries for accuracy and ensure that their drivers are operating within the bounds of company, state and federal speed limits, governmental time-in-service regulations and other company or governmental regulations.

### SUMMARY

The present disclosure relates generally to a system and method of verifying driver log entries against corresponding GPS data to verify the accuracy of the entries and to identify exceptions and data inconsistencies between the log entries and the GPS data.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a sample of independently derived time and location information used as part of the log verification process according to the present disclosure.

FIG. 2 illustrates a prior art sample log book page for use with the system of the present disclosure.

FIG. 3 is a flow chart of an embodiment according to the present disclosure illustrating the overall process of receiving, validating and transforming GPS coordinates into Locations, Driving time required and Distance covered.

FIG. 4 is a flow chart of a process according to the present disclosure illustrating the verification of driver GPS data against corresponding log data, once the process of FIG. 3 has been completed.

FIG. 5 is a flow chart of a process according to the present disclosure illustrating the verification of truck GPS data with corresponding log data, once the process of FIG. 3 has been completed.

FIG. 6 is a flow chart of a process according to the present disclosure illustrating the verification of trailer GPS data against corresponding log data, once the process of FIG. 3 has been completed.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

Logs in the transportation industry may be maintained for drivers, trucks or tractors, and also for trailers. Each of the trucks and trailers may be equipped with a recording device including a GPS receiver, linkage into the engine management system, and some form of on-board data storage. Such devices are well-known in the industry and will not be described in any detail herein. It is also known to include some form of remote data communication function with these data acquisition systems. Regardless of whether the data is streamed to a collection point in real time or downloaded at the conclusion of a work session, these data acquisition devices may record time that the vehicle was moving, the distance the vehicle moved, the speed at which the vehicle moved at any moment during movement, the course of movement of the vehicle, and/or engine running time.

Such a data acquisition system or mobile unit may be commonly found in the transportation industry and may be mounted in either a truck or tractor or a trailer. These systems or units may ideally be tamper-proof and operable without interference from the driver or any other person. It is known to mount the units in a hidden or inaccessible location to further deter tampering. A unit mounted within a trailer may be battery powered so that data may be acquired while the trailer is not connected to any tractor or other source of power. Alternatively, the unit mounted within a trailer may be solely powered by the power supplied by the tractor and only record data when connected to a tractor. As a further alternative, a trailer may include a unit that operates from both battery power and from tractor power. Solar panels or other passive power sources may be included in the trailer as well within the scope of the present disclosure.

A data acquisition and location unit mounted to tractor may be preferably powered by the electrical system of the tractor and should record data essentially at all times the tractor has power.

Additional operational parameters may also be recorded for maintenance and other purposes, but these basic time and movement data are most relevant to the present disclosure. For the purposes of this disclosure, reference will be made to “the vehicle” and this reference is intended to include both tractors and trailers or any other vehicles to which a unit or system may be attached for data acquisition. These time and movement data represent an electronic log of vehicle movement and operation. The sample interval for these data acquisition systems may range from one second or less, and up to five to ten minutes or more. At each sample interval, the data acquisition device may record whether the vehicle is currently moving, the current location of the vehicle, the current velocity of the vehicle, and, in the case of the tractor, whether the engine is running.

Drivers also are required to keep a log of their activities. Traditionally, these logs have been paper logs but they may be kept in any number of forms, either electronic or hardcopy. In such a log, a driver would record, at fifteen minute intervals, whether he was off-duty, in the sleeper cab (if the tractor is so equipped), driving, on-duty but engaged in non driving activities, such as loading, or other related work activities. Current work rules for drivers place limits on the maximum number of hours a driver can be on-duty and driving before a rest period is required, and the number of hours a driver may operate a vehicle before a rest period is required. For example, a driver may be limited to a maximum work day of fourteen hours, and cannot drive more than eleven hours in any given work day. Once the driver has reached either of these limits, the driver may be required to take mandatory rest period of at least ten hours before he or she may reset the eleven and fourteen hour limits and begin a new work session. There may also be rules regarding the total number of hours of driving a driver may accumulate over an extended period of time. For example, a driver may be limited to no more than seventy hours of driving within an eight consecutive day period.

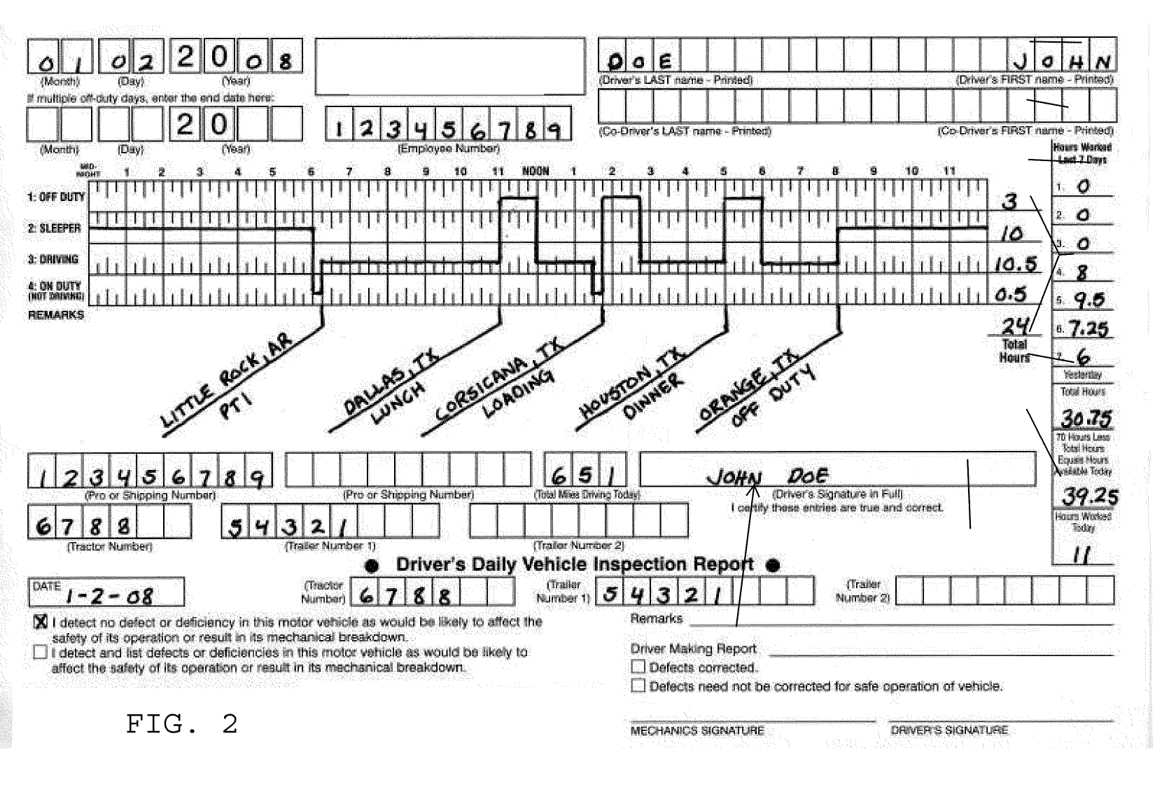

A sample log book page is illustrated in FIG. 2. From the driver's log, it can be determined for any given work session, whether the driver was on-duty more or less than the allowable work day, and whether the driver drove more or less than the allowable driving session, between the recorded rest periods. As noted above, these data are typically recorded at fifteen minute intervals, on the quarter-hour. If a driver begins one of the different status intervals (on-duty, driving, loading, standing by, etc.) in the middle of a fifteen minute period, the driver may mark the entire period as being for that activity. Or, the driver may mark the activity as beginning at the end of the present quarter-hour period. The driver's log may also record an identification number for the tractor driven, an identification number for the trailer(s) moved with the tractor during the work session, the miles driven and the start and end destinations for any trips taken. Each log book should indicate the entire twenty four hour period in which the work session occurred.

Since drivers may be compensated by the mile or by the completed trip, there are incentives for drivers to falsify log entries so that they are apparently complying with the work rules but are able to complete more miles or trips before a required rest period. Alternatively, drivers may exceed company or regulatory speed limits to complete more miles, or, to finish a delivery before reaching their maximum hours in driving or on-duty. Periodic audits by regulatory agencies or by the company operating the vehicles may seek to match the driver logs with the tractor and trailer logs to verify that the time and activity reported by the driver matches with the independently recorded data.

These audits have conventionally done by hand and are very labor intensive. Due to the time required to verify and reconcile a single driver's log, it has not been feasible to undertake large scale audits or verification of driver logs to ensure compliance with company and regulatory requirements.

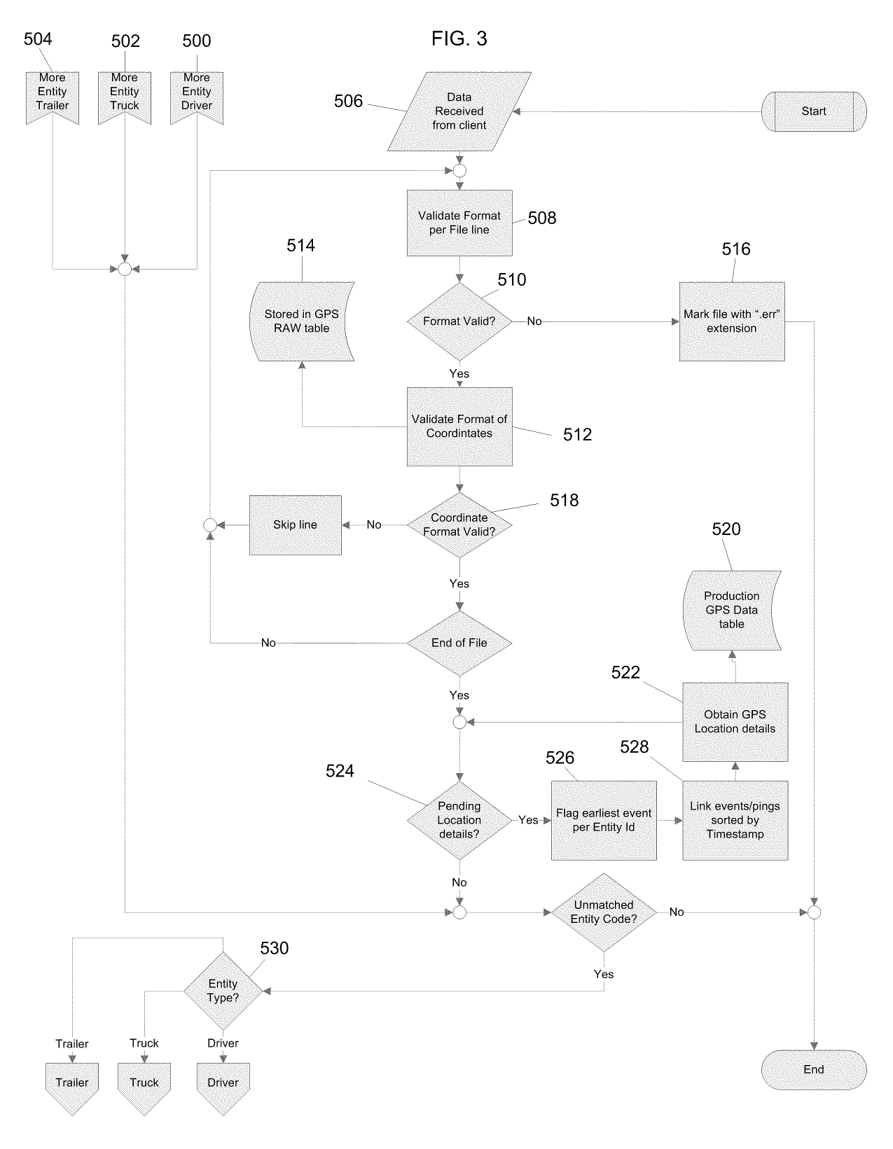

FIGS. 3 to 6 illustrate a series of methods for verifying and converting the corresponding GPS data (which includes time and location information that is independently gathered from the log) segregated by driver, truck or trailer, matching events recorded within the GPS data to the corresponding logs and addressing any discrepancies or exceptions found between the processed GPS data and the individual logs.

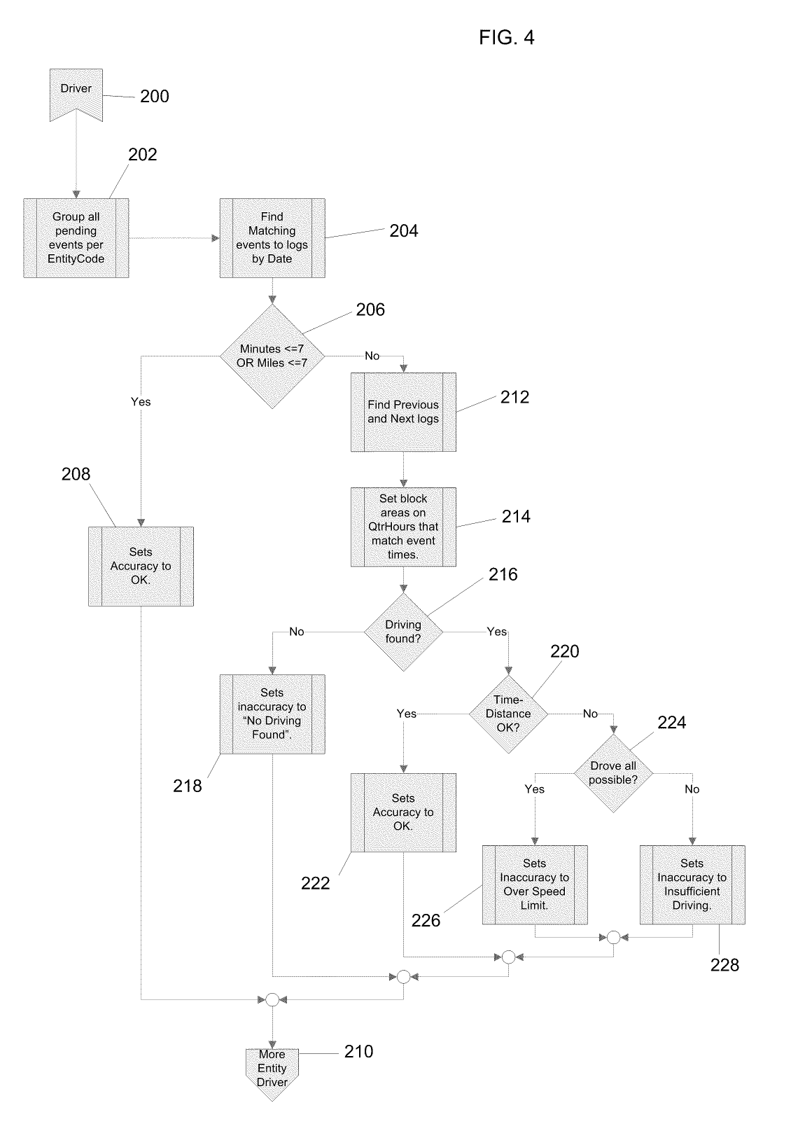

FIG. 3 includes a flow chart illustrating a process where independent information or data from a data acquisition unit including a GPS receiver is received and evaluated to determine whether the data will be usable to identify locations, distance and driving time required to travel between events. FIG. 4, 5, 6 also includes steps for adjusting the data so that the time intervals inherent in the data correspond better to the time intervals including in the logs.

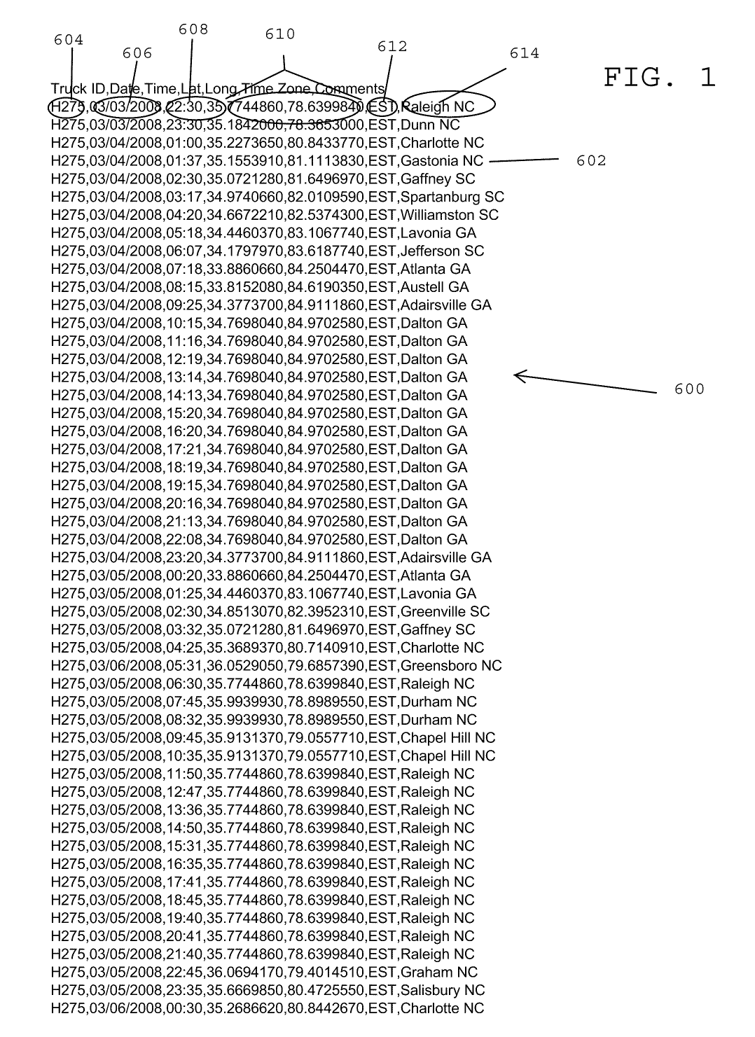

In FIG. 3, data may be received from GPS units that are associated with one of the truck or the trailer in a block 506. Typically, this data may be received in a standard data format, such as is illustrated in FIG. 1. In this non-limiting example, a data set 600 from the data acquisition unit is in a comma separated value or csv format, where each line 602 indicates an event that was captured by the data acquisition unit. Each line shown includes a truck ID 604, a date stamp 606 and a time stamp 608, a location in a lat/long coordinate pair 610, a time zone 612 in which the event took place and a comment field 614. In the example of FIG. 1, the comment field has been populated with a notation of the town or city nearest the coordinates of the event. FIG. 1 is illustrative only and it is not intended to limit the present disclosure to this data set format. Other data formats may be used within the scope of the present disclosure and it is also anticipated that similar data files may be received which are associated with trailers or drivers as well, with the appropriate Trailer or Driver ID substituted for the Truck ID of FIG. 1.

This GPS data or file may then be analyzed to ensure that format is valid in a block 508. If the format is not correct and usable, in a block 516 the GPS file may be marked with an extension that indicates that the file is unusable. If the file format is correct, the format of the coordinates is next validated in block 512 prior to storing the data in a GPS Raw table in a block 514. In the event such format is incorrect that line is skipped and the revision continues until the end of the file.

Once the coordinates have been recognized as valid values, a process in blocks 522, 524, 526 and 528 may be used to obtain a geographic location and the number of miles driven between GPS data events or pings. In a first step, in block 524, the data regarding events to be analyzed is reviewed to see if any of the event data lines lack any of the details. If so, the lines are marked in sequence according to the earliest time stamp in block 526. The events may then be arranged and possibly linked together from earliest to latest in block 528. Finally, the GPS coordinates organized by time stamp may then be validated using a routing, mileage and mapping software such as but not limited to PC*MILER in block 522 before being stored in a production database 520.

Having obtained the location details per event, the next phase is to match each of those events to an Entity code (Driver ID, Truck ID, or Trailer ID). Starting in block 530, the data are arranged according to each Entity type—Driver, Truck or Trailer.

Once the data from the GPS file has been validated, collected and scrutinized to obtain a geographic location and the distance driven between points A and B in a determined period of time as illustrated in FIG. 3, next is the evaluation of the GPS data against the driver's log, as illustrated in FIGS. 4 to 6. FIGS. 4 to 6 each represent a comparator of sorts which operates to match up the location data and the log information.

FIG. 4 illustrates a flow chart for reviewing the processed GPS data segregated by Driver ID against a driver's log. Beginning at a block 200, the data is evaluated according to each Driver ID found in the file. At this point, in block 200, the driver log would be already captured and converted into digital format for evaluation and associated with corresponding GPS data. In a block 202, all of the entries within the file are grouped by Entity code, in this case by Driver ID. In a block 204, the various GPS events are paired with their respective driver's log information with the most closely matching date and time. In a block 206, each of the events is examined to see if either the elapsed time of the event or miles covered during the event exceed a set de minimis threshold, this flexible threshold is currently set to seven minutes or seven miles. Since a driver's activities (Driving, On Duty Not Driving, Sleeper Berth and Off Duty) are recorded in a log divided with quarter hour segments as the minimum time unit, the focus is on examining GPS events that are more than 7 minutes apart or which distance between the previous ping and the one under observation is more than 7 miles. Lesser values represent numbers that could round down to zero within the structure of the quarter hour segmented driver log. For a vehicle travelling at normal highway speeds, a distance of seven miles covered would roughly correspond to approximately seven minutes elapsed time.

If the particular events are found to be less than the de minimis threshold, they can be marked and excluded from the remainder of the evaluation in a block 208. For those GPS events found to be above the threshold, the adjacent logs are searched in a block 212, in preparation for the pairing. It is common for GPS events approaching midnight time to occupy a trajectory that crosses from one day to the next, which is the reason for having adjacent logs or log pages readily available for evaluation when applicable. In a block 214, the events are matched up to the respective quarter hour clock segments. Within each event segment, the data may be further evaluated to determine if any driving took place within that segment in a block 216. If no driving was found, the event may be marked NO DRIVING FOUND and excluded from further evaluation in a block 218.

If driving is found within a segment, the event is further analyzed in a block 220 to determine if the time used to cover the distance in the specific segment is within approved limits based on the time elapsed and maximum speed limits set by company policy or regulatory requirements. The parameter used to evaluate whether the distance was OK may be the association between the GPS time required (for example but not limited to data obtained by PC*Miler) to cover the specific distance and the driving time logged by the driver. If there is a discrepancy between the driving time recorded in the driver's log and the time required to cover the specific distance, this exception may be flagged for further evaluation to determine the likely cause or source of the discrepancy.

If the time-distance relation is sufficiently consistent between the driver log and the GPS data, and this distance is acceptable based on the approved limits, the event may be marked and excluded from further consideration in a block 222. If the time expended is not within approved limits, the event is further evaluated to see if the driver was driving for the entire segment in a block 224. If the driver was driving for the entire time and the distance was over the approved limit, then the event may be marked as OVER SPEED LIMIT in a block 226. In a block 228, if the driver was not indicated to be driving entire time, then the event may be flagged suspect as having INSUFFICIENT DRIVING.

After evaluation of the set of GPS data available for a driver in the given file, another Driver ID may be selected and this cycle repeated, in block 210 until each Driver ID in a particular file is married with and evaluated against the correspondent log data.

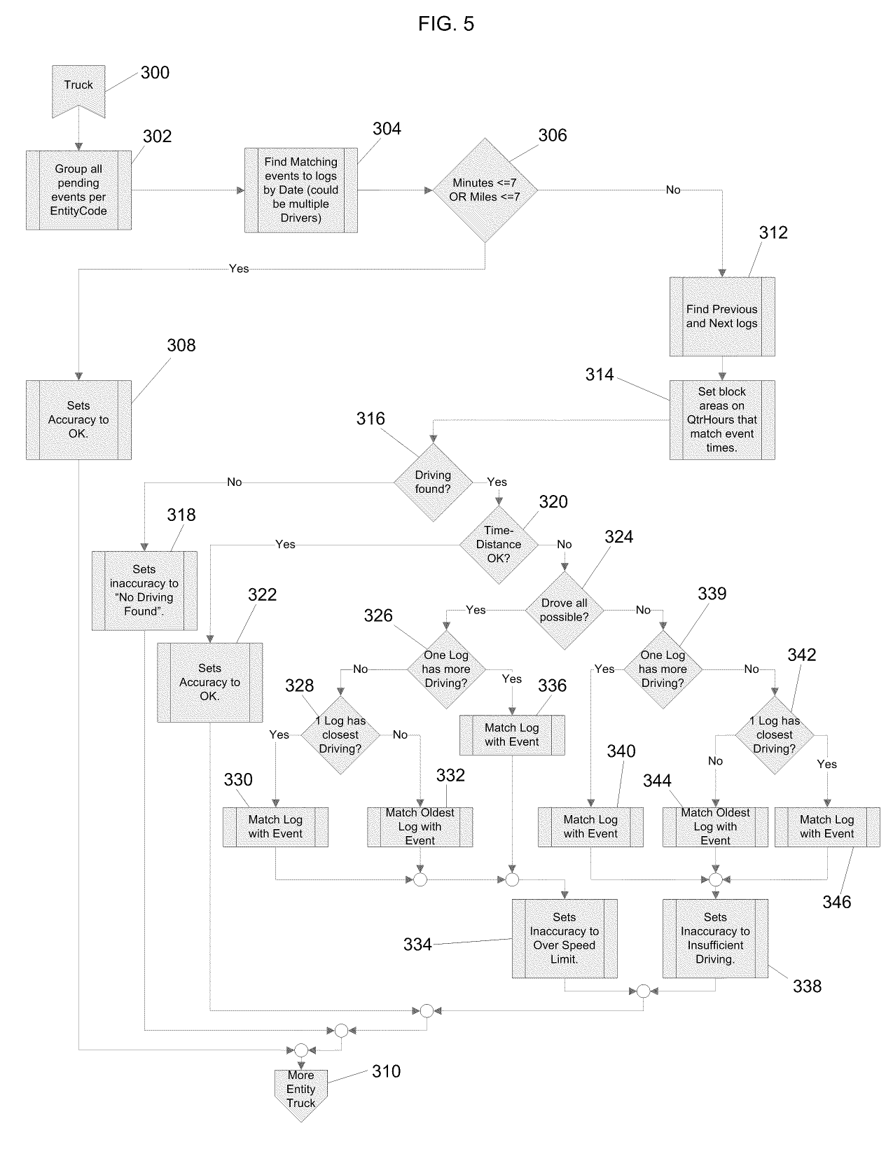

FIG. 5 illustrates a similar process used for reviewing the GPS data by Truck ID instead of Driver ID or Trailer ID. This distinction between the type of ID is performed in a block 300 and just as the previous comparison, the GPS data correspondent to a Truck ID is evaluated against the driver's log data.

The GPS data available is grouped by Truck ID, in a block 302. Next, the correspondent log or logs—if more than one driver is involved with the same truck—are searched in order to do the pairing, all happening in a block 304. For example, a truck may have been operated by multiple drivers during the course of a day, either as co-drivers for an over-the-road situation, or by drivers on separate shifts during a work day for a short-haul situation. In a block 306, a de minimis filter to remove events of less that seven minutes or seven miles may be applied to the data with these entries being marked OK in a block 308.

In a block 312, for those GPS events found to be above the threshold, the adjacent logs may be identified to see if there is continuity between adjacent logs that may be aggregated or which may help identify incorrect or inaccurate entries. In a block 314, the events are matched up to the respective quarter hour clock segments.

Once the data have been consolidated and aggregated, the process beginning at a block 316 is initiated by querying whether the event includes any driving activity. If no driving is found in the entry, the entry may be marked as not having any driving in a block 318 and the next truck log data entry evaluated.

If driving is found within the entry, in a block 320, the driving time found within the log is verified against the time and distance extracted from the GPS data. If the driving time recorded in the log matches the GPS calculated time and distance (within acceptable tolerances), in a block 322, the entry can be marked as accurate and the evaluation process may move to the next entry. If the time logged and the processed GPS data do not match, in a block 324, the log is checked to see if the truck was driven all of the possible time in the segment.

If the truck was driven the entire segment, the segment may be evaluated to see if several driver logs include entries for driving the particular truck during that segment. In a block 326, if one of the driver logs covering the segment has more driving than the other log(s), then in a block 328 the driver log with the most distance is evaluated to see of that driver logged mileage closest to the actual distance recorded as being travelled by the GPS data. If the distances match in block 328, then the log of the driver may be matched to the log of the truck in a block 330 and then the entry may be marked as being OVER SPEED LIMIT in a block 334. The next truck log entry may then be evaluated. If neither driver log is sufficiently close to the GPS distance, the driver log entry that is the oldest may be associated with the event in a block 332 and the event marked as OVER SPEED LIMIT in block 334.

It should be noted that if there is only one log associated with the particular event being evaluated as described in the above paragraph, then that driver log entry may be marked as being OVER SPEED LIMIT. The process may still include the evaluation of possible multiple driver logs being associated with a particular truck log event, although the outcome is simplified when only a single driver log is in question.

If in block 324, it was found that the truck was not driven the entire time, the same sort of validation and matching of log entries is carried out in blocks 338, 340, 342, 344 and 346, with the appropriate driver log entry being marked as INSUFFICIENT DRIVING in a block 338.

Once the particular truck log entry being evaluated is marked as NO DRIVING FOUND, or matched with a driver log entry and the driver log entry is marked as appropriate (ACCURACY OK, OVER SPEED LIMIT, INSUFFICIENT DRIVING), the next truck log entry may be evaluated in a block 310.

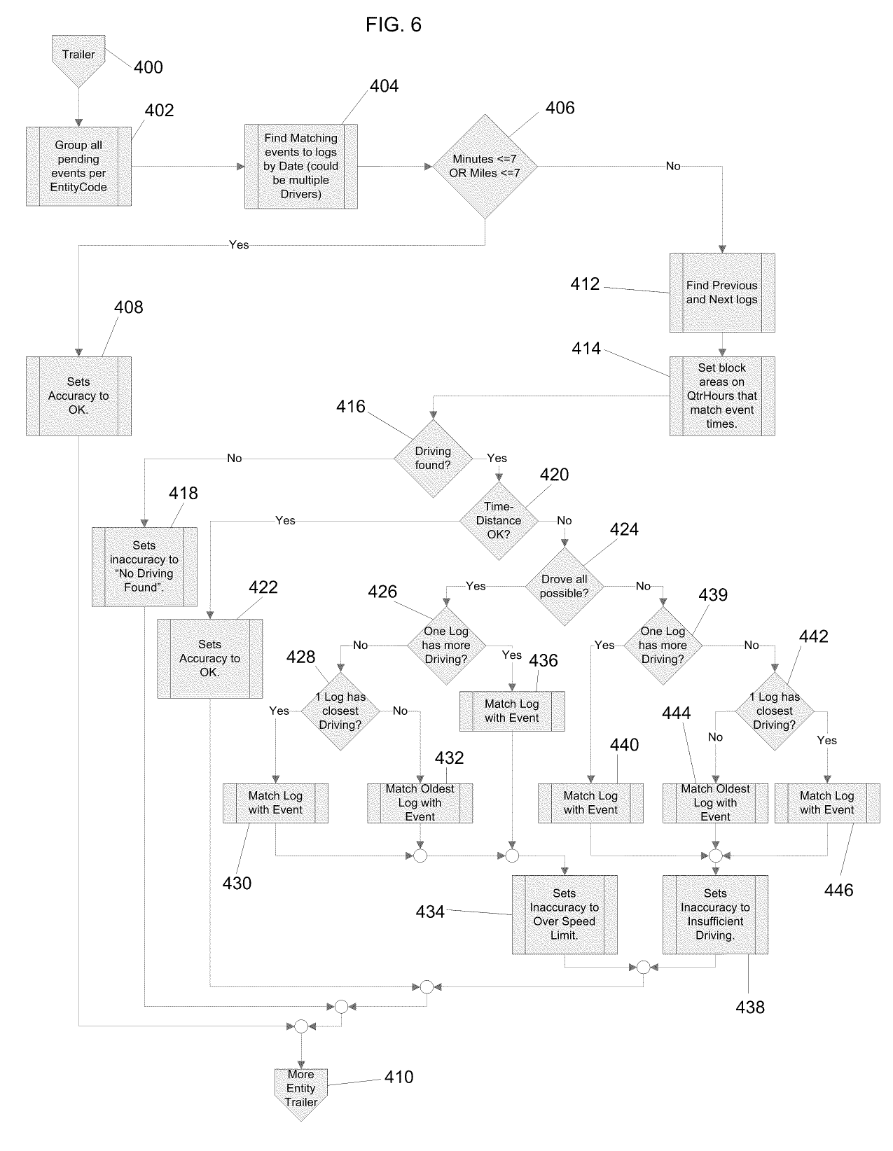

FIG. 6 illustrates a similar process used to capture in digital form and evaluate trailer logs. The process of FIG. 6 mirrors the process of FIG. 5 and where possible, blocks with similar functions have been numbered similarly. In FIG. 5, the reference numbers begin with 3xx while the corresponding reference number in FIG. 6 would be 4xx for the block with the same or similar function. Reference made to trucks in the description relating FIG. 5 may be equated to trailers when the description is applied to FIG. 6.

The result of the analysis and validation of the various log entries against the corresponding GPS data may be a complete record where all of the entries in a particular log are listed with status of the accuracy or usability of entry or the related data listed. Alternatively, since many audits are performed to identify and/or quantify the number of non-compliant events or exceptions, the result of the analysis may be in the form of an exception report. Such a report may have a summary listing of all the evaluated entries and some statistics relating thereto, along with a more detailed listing of those entries which were flagged as being logically inconsistent, indicating possible violations of company or regulatory standards, or otherwise unacceptable. This exception report can then be used to clarify logical inconsistencies and allow further evaluation of those entries to ensure compliance with the appropriate and applicable standards. Once all of the logical inconsistencies are addressed, which might mean they are corrected and reevaluated or that they are excluded from further consideration, the remaining exceptions may be reviewed.

Audits or evaluations of driver, truck and trailer logs may be performed for a variety of reasons that may be either internal or external to the transportation company who owns or operates the assets and/or employees being evaluated. Some audits may be performed at the request or requirement of an appropriate regulatory agency. Others may be performed due to internal review and evaluation requirements. Still others may be performed as part of labor or employee evaluations. The particular reason for initiating the analysis may alter the nature of the evaluation of the exceptions, but the overall process of validation of the log entries should remain essentially the same regardless of the reason for performing the validation.

While it is noted that the above description contemplates the conversion of conventional paper logs from drivers into a digital format for comparison and validation against GPS data, it is also anticipated that the present disclosure is operable with data that is already collected in electronic formats. As long as there is a need or desire to reconcile data collected by drivers regarding their activities, with data collected regarding the movement or operation of trucks and trailers, the present disclosure will permit such reconciliation to take place. Sources of accurate vehicle or asset movement data have been listed herein as being GPS related but it is not intended to limit the present disclosure to solely using current GPS technology. GPS is used herein as being a source of accurate movement or position information that may be used to verify log entries. Other devices, methods, procedures, technologies, etc, may be used to provide accurate, time-stamped data that may be correlated to the log entries to permit the validation described above to be carried out. Such alternative technologies may be presently available or developed in the future. They may be terrestrially based or may involve data received from non-earthbound sources.

While the present disclosure has been presented to relate to validation of log book data with data regarding vehicle operation from other sources, it is anticipated that the present disclosure has application beyond just this utility. For example, it is anticipated that the process of the present disclosure may allow analysis with respect to routing, maintenance, road or usage tax calculation, fuel usage, or other applications or processes that might be carried out by a transportation firm. Further, the processes of the present disclosure may be integrated with these same applications and provide for a comprehensive vehicle and driver tracking and analysis package. It is also anticipated that the process of the present disclosure may incorporate a mapping element to provide a visual analysis of where events marked as suspect have taken place. Such a utility may provide a quick reference that permits the suspect events to be explained by looking at the purported location of the event captured in the data. The map may show an obvious error based on the location clearly distant from where the truck or trailer should actually have been located. Alternatively, the map may show a particular location that is known to generate suspect data lines but which are readily explainable from the location context.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A method of verifying the accuracy of a driver log, the method comprising:
providing at least one driver log covering a particular time period, the log including time interval, location and activity information recorded at set time intervals;
acquiring independent information for one of a truck driven by the driver and a trailer moved by the driver, the independent information including time interval and location information covering at least a portion of the same time period as the log, the independent information being recorded at time intervals that are different from the time interval of the log, with the time interval and location information being arranged chronologically;
validating the contents of the independent information;
adjusting the independent information to correspond to the time intervals of the log;
comparing the log information to the adjusted independent information and identifying discrepancies;
filtering to remove discrepancies below a de minimis threshold;
aggregating time and location information to analyze discrepancies and possibly explain discrepancies; and,
generating a list of discrepancies not removed by the filtering step or the aggregating step.

2. The method of claim 1, further comprising the driver log time intervals being quarter hour intervals.

3. The method of claim 1, further comprising the independent information being recorded at event driven intervals when a change of activity for the truck or trailer occurs, and indicating the time and location that the change of activity took place.

4. The method of claim 1, wherein the driver log and the independent information are compared in a digital format by an automated process.

5. The method of claim 4, wherein the driver log is a hard copy record, and further comprising the scanning and conversion of the hard copy record into an digital format for input to the automated process.

6. The method of claim 1, further comprising providing driver logs from adjacent time periods including location and activity information at a set time interval and aggregating adjacent time and location information from adjacent logs to analyze discrepancies.

7. The method of claim 1, wherein the independent information is generated by a device mounted to the truck or the trailer.

8. The method of claim 7, wherein the device is a satellite location device mounted to the truck or the trailer.

9. The method of claim 1, wherein the driver log includes information relating to driver status for the time period covered by the log, with the driver status being recorded as one of driving, on duty not driving, in sleeper berth and off duty, for the entire time period.

10. The method of claim 1, wherein the independent information is recorded at irregular intervals.

11. The method of claim 1, wherein the independent information is validated at least in part by comparison to an automated routing software application.

12. A method of verifying the accuracy of a transportation log, the method comprising:
providing at least one transportation log related to one of a driver, a truck and a trailer, the log covering a particular time period and including time interval, location and activity information recorded at set time intervals;
acquiring independent information for one of a truck driven by the driver and a trailer moved by the driver, the independent information including time interval and location information covering at least a portion of the same time period as the log, the independent information being recorded at time intervals that are different from the time interval of the log, with the time interval and location information being arranged chronologically;
validating the contents of the independent information;
adjusting the independent information to correspond to the time intervals of the log;
comparing the log information to the adjusted independent information and identifying discrepancies;
filtering to remove discrepancies below a de minimis threshold;
aggregating time and location information to analyze discrepancies and possibly explain discrepancies; and,
generating a list of discrepancies not removed by the filtering step or the aggregating step.

13. The method of claim 12, further comprising the driver log time intervals being quarter hour intervals.

14. The method of claim 12, further comprising the independent information being recorded at event driven intervals when a change of activity for the truck or trailer occurs, and indicating the time and location that the change of activity took place.

15. The method of claim 12, wherein the driver log and the independent information are compared in a digital format by an automated process.

16. The method of claim 15, wherein the driver log is a hard copy record, and further comprising the scanning and conversion of the hard copy record into an digital format for input to the automated process.

17. The method of claim 12, further comprising providing driver logs from adjacent time periods including location and activity information at a set time interval and aggregating adjacent time and location information from adjacent logs to analyze discrepancies.

18. The method of claim 12, wherein the independent information is generated by a device mounted to the truck or the trailer.

19. The method of claim 18, wherein the device is a satellite location device mounted to the truck or the trailer.

20. The method of claim 12, wherein the driver log includes information relating to driver status for the time period covered by the log, with the driver status being recorded as one of driving, on duty not driving, in sleeper berth and off duty, for the entire time period.

21. The method of claim 12, wherein the independent information is recorded at irregular intervals.

22. The method of claim 12, wherein the independent information is validated at least in part by comparison to an automated routing software application.

23. A system for verifying the accuracy of a transportation log, the system comprising:
a log data module configured to receive at least one transportation log related to one of a driver, a truck and a trailer, the log covering a particular time period and including location and activity information recorded at set intervals;
an independent location analyzer into which are input independent information for one of a truck driven by the driver and a trailer moved by the driver, the independent information including time interval and location information covering at least a portion of the same time period as the log, the independent information being recorded at a time intervals that are different from the time interval of the log, the analyzer configured to validate the contents of the independent information;
a comparator configured adjust the independent information to correspond to the time intervals of the log and to compare the log information to the independent information and identify discrepancies;
a filter module configured to apply one or more filters to remove discrepancies below one or more de minimis thresholds;
an aggregator configured to aggregate adjacent time and location information in the log information to analyze discrepancies and possibly explain discrepancies; and,
a report generator configured to generate a list of discrepancies not removed by the filter module or the aggregator.
